(19) United States
(12) Patent Application Publication
(10) Pub. No.: US 2025/0026223 A1
(43) Pub. Date: Jan. 23, 2025

(54) TRUTH AND CHARGING

(71) Applicant: PowerFlex Systems, LLC, San Diego, CA (US)

(72) Inventor: Kellock IRVIN, San Franciso, CA (US)

(21) Appl. No.: 18/675,980

(22) Filed: May 28, 2024

Related U.S. Application Data
(60) Provisional application No. 63/515,104, filed on Jul. 23, 2023.

(51) Int. Cl. B60L 53/62; B60L 53/68

(52) U.S. Cl. CPC B60L 53/62; B60L 53/68

(57) ABSTRACT

Certain aspects of the present disclosure provide techniques for truth and charging. One embodiment of a method includes receiving a charge request from a user for a charging station that includes an expected charging time and an expected energy usage for charging an EV, receiving data related to a charge at the charging station that is associated with the charge request, and comparing the expected charging time with the actual charging time and the expected energy usage with the actual energy usage. Some embodiments include determining whether the charge request was accurate, determining whether the user is accurate, and in response to determining that the user is not accurate, taking corrective action to encourage the user to adjust a future charge request to become more accurate.

### CROSS REFERENCE

This application claims the benefit of U.S. Provisional Application Ser. No. 63/515,104, entitled truth and charging, filed on Jul. 23, 2023, which is hereby incorporated by reference in its entirety.

### INTRODUCTION

Aspects of the present disclosure relate to managing charging of an electric vehicle of a user based on historical data regarding that user's previous charge requests and actual charge needs.

### BACKGROUND

Increased popularity of electric vehicles (EVs) has led to an increased need for charging stations, especially in urban areas. Some charging stations may utilize a large number of charging bays to facilitate many plugged-in EVs; however, it is often the case that not all plugged-in EVs can be charged at once owing to limitations of the electrical infrastructure. As such, many of these charging stations load-share the charging capacity between the plugged-in EVs during times of peak charging demand. To help address load management, many EV charging systems provide a user interface for a user to enter a request for a charging session with relevant information. The user interface may provide a form that the user can access and customize, to provide, for example, a vehicle identifier, user identifier, a charging time request, and/or an energy delivery request (e.g., an amount of energy, such as 25 kWh). Unfortunately, once the form is populated, users often do not change the values in the form and thus inadvertently misrepresent how much energy they actually need or time they actually have to fulfill that energy need when they create a new session request.

As an example, a user of a charging station may be provided with a templated interface that automatically populates that the user needs to leave in 2 hours and needs 75 kWh of energy. This information is sent to the charging station and the charging station prepares and schedules EV charging of this and other EVs to accommodate that request. However, some days, the user may leave the EV plugged into the charging station for 8 hours and may only need 30 kWh of energy. Thus, the user may have been making a demanding request, but may actually not have the time pressure and/or the energy need he/she requested. In other cases, users knowingly misrepresent their need in order to “game” the system to get their charge delivered with higher than needed priority. For example, a charging bad actor may request more energy than needed, earlier in the day than needed, and in response a load management algorithm may prioritize a high rate of charge for the charging bad actor's vehicle earlier in the day.

While user-driven load management is in theory an efficient use of charging capacity, users must be accurate and truthful in their requests for charge capacity. However, be it human nature or otherwise, it is too often the case that users are not truthful in their requests for charging capacity, which creates technical problems for charging stations, such as inefficient charge capacity utilization, poor load management, and/or load management that effectively responds to bad faith requests and may consume energy that would otherwise be allocated to good faith actors. This creates a poor user experience for the other users of the charging station and for the site manager trying to support the needs of the drivers.

Thus, a need exists in the industry for systems and methods to address erroneous user-provided charging information in order to improve charge capacity utilization and load management effectiveness.

### SUMMARY

Certain aspects of the present disclosure provide techniques for truth and charging. One embodiment of a method includes receiving a charge request from a user for a charging station that includes an expected charging time and an expected energy usage for charging an EV, receiving data related to a charge at the charging station that is associated with the charge request, and comparing the expected charging time with the actual charging time and the expected energy usage with the actual energy usage. Some embodiments include determining whether the charge request was accurate, determining whether the user is accurate, and in response to determining that the user is not accurate, taking corrective action to encourage the user to adjust a future charge request to become more accurate.

Embodiments of a system include an edge environment that includes a memory component and a processor. The edge environment may include an edge cluster that, when executed by the processor, causes the system to receive a charge request from a user for a charging station that includes an expected charging time and an expected energy usage for charging an electric vehicle (EV), receive data related to a charge at the charging station that is associated with the charge request, where the data includes an actual charging time and an actual energy usage for the EV, and compare the expected charging time with the actual charging time and the expected energy usage with the actual energy usage. Some embodiments may be configured to determine, based on comparing and a predetermined threshold for accuracy, whether the charge request was accurate, determine, from data related to whether the charge request was accurate and other data associated with whether another charge request of the user was accurate to, whether the user is accurate, where determining whether the user is accurate is based on predetermined criteria, and in response to determining that the user is not accurate, take corrective action to encourage the user to adjust a future charge request to become more accurate.

Embodiments of a non-transitory computer-readable storage medium include logic, that, when executed by a computing device, causes the computing device to receive a charge request from a user for a charging station that includes an expected charging time and an expected energy usage for charging an electric vehicle (EV), receive data related to a charge at the charging station that is associated with the charge request, where the data includes an actual charging time and an actual energy usage for the EV, and compare the expected charging time with the actual charging time and the expected energy usage with the actual energy usage. In some embodiments, the logic causes the computing device to determine based on comparing and a predetermined threshold for accuracy, whether the charge request was accurate, determine from data related to whether the charge request was accurate and other data associated with whether another charge request of the user was accurate to, whether the user is accurate, where determining whether the user is accurate is based on predetermined criteria, and in response to determining that the user is not accurate, take corrective action to encourage the user to adjust a future charge request to become more accurate.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts a computing environment for truth in charging, according to embodiments provided herein;

FIG. 2 depicts a software configuration for edge environment, according to embodiments provided herein;

FIGS. 3A-3C depict example hardware configurations for the edge environment, according to embodiments provided herein;

FIGS. 4A-4C depict hardware that may be utilized for the devices from FIGS. 3A-3C,

according to embodiments provided herein;

FIGS. 5A-5F depict a plurality of graphs indicative of a use case of a charging station, according to embodiments provided herein;

FIG. 6 depicts a spreadsheet further illustrating individual charging entries of various users, according to embodiments provided herein;

FIG. 7 depicts a flow diagram depicting implementation of truth in charging via the edge environment from FIGS. 1 and 2, according to embodiments provided herein; and

FIG. 8 depicts a flowchart for providing truth in charging, according to embodiments provided herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Embodiments disclosed herein include systems and methods for addressing erroneous user-provided charging information in order to improve charge capacity utilization and load management effectiveness. Some embodiments are configured to receive a user request for charging. The user request may include a user identifier, a vehicle identifier, a time request, and/or an energy delivery request. These embodiments may also determine historical requests and usage from the user, which may then be utilized to determine whether the user has historically been accurate in his/her requests (whether intentionally or not). As a specific example, the user may indicate that he/she needs a full charge by 2 PM on a given day, but then leaves the vehicle at the location until 5 PM that day. Similarly, it may be determined that the user only utilized a certain amount of energy and, thus only needed 20 miles of charge, instead of a full charge. If it is determined that a user has been inaccurate to a predetermined degree and/or the user has been inaccurate a predetermined number of times, when a new request is received, embodiments may adjust aspects of the energy delivery (e.g., start time, delivery rate, etc.) during a charging session to meet a predicted need based on the historical usage, rather than the requested need. This may generally be referred to as charge request modification.

### Example Environment

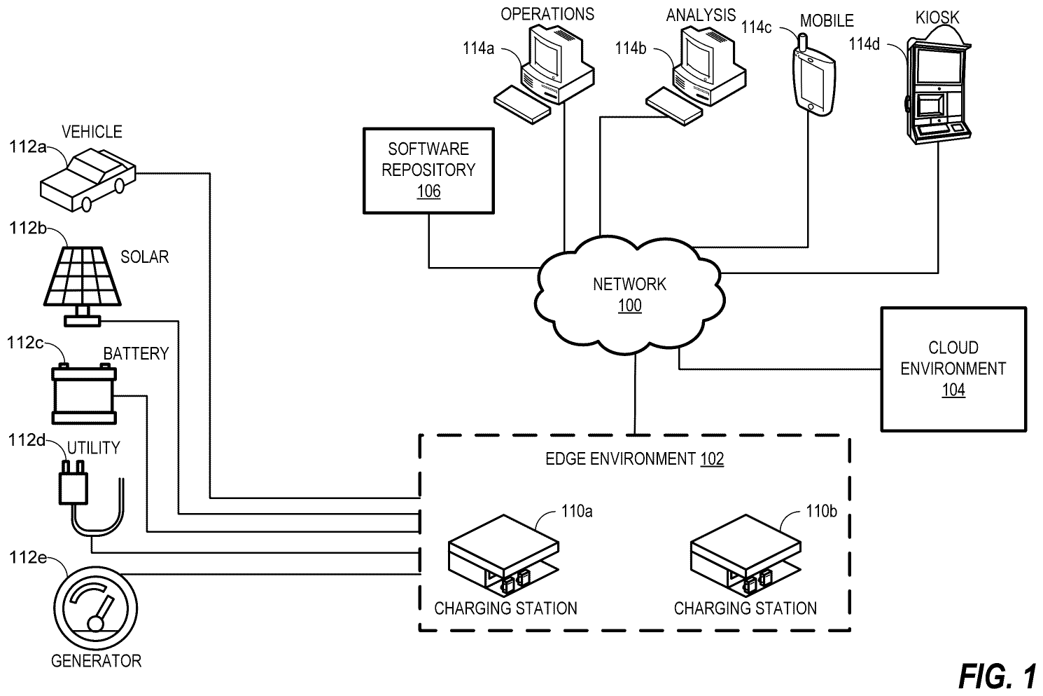

FIG. 1 depicts a computing environment for charge request modification, according to embodiments provided herein. As illustrated, the computing environment includes a network 100 that is coupled to an edge environment 102, a cloud environment 104, and a software repository 106. The network 100 may be configured as any wide area network (WAN, such as the internet, power network, cellular network, etc.), local network (e.g., LAN, Ethernet, Wireless-Fidelity, etc.).

The edge environment 102 may include and/or be coupled with one or more charging stations 110, such as charging station 110a. Note that other types of charging stations are possible. The charging station 110a may be configured to charge one or more electric vehicles (EV) and/or other electric devices. The charging station 110a may utilize any protocol of charging, communication, and/or control such as open smart charging protocol (OSCP), open charge point interface (OCPI), ISO 15118, OpenADR, etc. and may represent Level 1, Level 2, Level 3, and higher powered charging stations, as applicable.

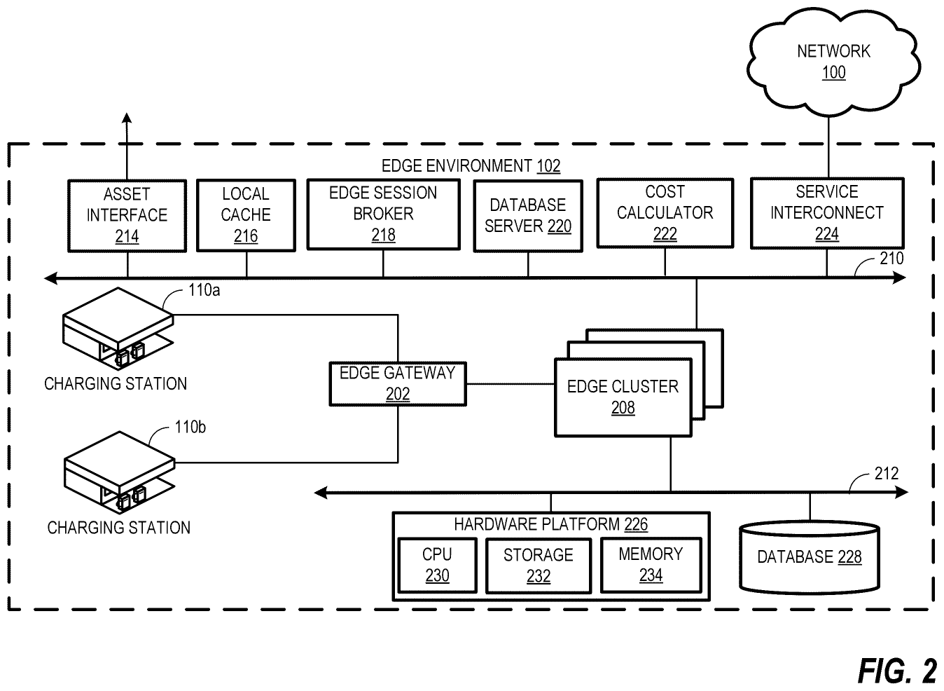

As described with reference to FIG. 2, the edge environment 102 may be configured as an interface between the charging stations 110 and the network 100. Some embodiments may be configured such that the computing power at one or more of the charging stations 110 may be controlled dynamically (e.g., increased or decreased, limited, etc.) and the edge environment 102 may be configured to provide fast processing of data, as well as processing when access to the network 100 may be limited or unavailable.

The cloud environment 104 may be coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more charging stations 110 and/or one or more energy sources 112.

Also coupled to the edge environment 102 are energy sources 112. The energy sources 112 may include a vehicle 112a, a solar device 112b, a battery 112c, a utility 112d (such as a coal plant, solar plant, wind farm, etc.), a generator 112e, and/or other sources of energy. While not an exhaustive list, the energy sources 112 may provide energy to the charging stations 110. In some embodiments, the charging stations 110 may send excess energy back to vehicle 112a, battery 112c, and/or to the utility 112d. Regardless, the edge environment 102 may monitor and/or modify the energy received from the energy sources 112 to be properly utilized by the corresponding charging station 110.

Also coupled to the network 100 is a software repository 106. The software repository 106 may be configured as a platform to program, store, manage, control changes, etc. to software that is implemented in the edge environment 102 and/or cloud environment 104. The software repository 106 may be configured as a proprietary service and/or may be provided by a third party, such as GitHub™.

Also depicted in FIG. 1 are ancillary devices 114. The ancillary devices 114 may include an operations device 114a, an analysis device 114b, a mobile device 114c, a kiosk 114d, and/or other devices. Specifically, the operations device 114a may be utilized to monitor and/or alter operations of the computing environment provided in FIG. 1. The analysis device 114b may analyze utilization, operation, charging, and/or other features of the computing environment. The mobile device 114c may represent an administrator device and/or a user device. As a user device, the mobile device 114c may initiate charging, payment, and/or perform other user-specific actions. As an administrator device, the mobile device 114c may perform administrative operations, analysis, and/or perform other actions. The kiosk 114d may be located at one of the charging stations 110 and/or remote therefrom and may provide user-specific or administrative actions, similar to that of the mobile device 114c. As will be understood, the ancillary devices 114 may each include a processor, a memory component, and/or other hardware and/or software for preforming the functionality provided herein.

### Example Aspects of an Edge Environment

FIG. 2 depicts a software configuration for edge environment 102, according to embodiments provided herein. As illustrated, the edge environment 102 may be coupled to the charging stations 110 via an edge gateway 202. Also included in the edge environment 102 is an edge cluster 208, which is coupled to communication bus 210 and hardware bus 212. The communication bus 210 may be coupled to an asset interface 214, a local cache 216, an edge session broker 218, a database server 220, a cost calculator 222, and a service interconnect 224. Similarly, the hardware bus 212 may be coupled to a hardware platform 226, which may include a processor, such as CPU 230, storage component 232, memory component 234, and/or other hardware components. Also coupled to hardware bus 212 is a database 228. Communication bus 210 provides a mechanism for all services that run on the edge and communicate with each other via a distributed message streaming system. The coupling of these aforementioned services 208-228 is accomplished via a distributed message streaming protocol such as NATS.

The charging stations 110a, 110b may represent any type of charging station (such as level 2, open charge point protocol (OCPP), etc.) and may be configured for serial bus communication, communication via a peer-to-peer communication protocol, such as Zigbee, and/or other wired or wireless communication protocol. Depending on the particular embodiment, the charging station 110a may represent a charging station of a first protocol and the charging station 110b may represent a charging station of a different protocol. The charging stations 110 may each include a plurality of charging bays for receiving EVs to charge. Through use of the edge environment 102, the charging stations 110 may be configured to dynamically allocate charge to one or more of the charging bays, based on demand. Specifically, some embodiments may be configured that the charging stations 110 include more charging bays than can be utilized simultaneously. As such, if the number of EVs (and specifically the charge demands of those EVs) exceeds maximum output of the charging stations 110, embodiments may be configured to dynamically schedule charging of each of the EVs, based on charge requests so that the EVs receive the requested energy by the time requested.

The edge gateway 202 may be configured to receive data, such as electric charging data, price charge data, vehicle data, etc. from the charging stations 110 and/or vehicles that are being charged. Additionally, the edge gateway 202 may be configured to abstract data received from the charging stations 110 to remove protocol specific distinctions. Thus, data output from the edge gateway 202 may be protocol relative to the protocol of data utilized by the particular charging stations 110. The edge gateway 202 may send the data to the edge cluster 208.

The edge cluster 208 may be the central message center in various embodiments. For example, when a user plugs a vehicle into a charging station 110, the edge cluster 208 receives data from the edge gateway 202, parses that data to access state data, and causes the state data to be sent to the database server 220. The edge cluster 208 also receives the data and creates a session entry, which may be stored in the local cache 216. The edge cluster 208 may additionally send the session entry to the cloud environment 104. The edge session broker 218 may also receive data related to the new session and will reach out to the database server 220 to access additional session data and solves for a charge curve.

The edge session broker 218 may produce data or signals that are sent to the edge cluster 208, which may be sent to the edge gateway 202 for potentially sending back to one or more of the charging stations 110. Information that may be reported might include current delivered over time (e.g., amperes), total energy delivered (e.g., kWh), power delivered over time (e.g., kW), voltage at the charging station 110 over time (e.g., V), charging station state (e.g., connected, disconnect, offline), alarms and/or messages about a state of the charging stations 110, information about the vehicle, such as state of charge, payment processing, etc. The charging stations 110 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy sources 112.

It should be understood that the edge cluster 208 is configured such that any message received by the edge cluster 208 may also be sent to the cloud environment 104, for example, if there is an interested subscriber. If not, the data may remain with the edge cluster 208. Thus, if a user of the mobile device 114c (FIG. 1) desires to claim a session, the mobile device 114c does not need to access the edge environment 102 directly. Instead, the mobile device 114c may connect with the cloud environment 104, which sends a message to the edge cluster 208 with an instruction to claim the session. As will be understood, the service interconnect 224 may be configured for establishing an HTTP, TCP, and/or other type of communication with the cloud environment 104 via the network 100.

Additionally, the hardware platform 226 represents any hardware for facilitating the processes and actions described herein. Specifically, the CPU 230 may be configured as any processor for executing instructions received from the hardware platform 226. The storage component 232 may be configured as long term storage, such as a hard drive or the like. The memory component 234 may include any of various types or read access memory or the like. The database 228 may be configured for additional storage and may be housed with the other hardware and/or elsewhere.

It should be understood that the components and/or services of FIG. 2 may be implemented in logic, such as software, firmware, and/or hardware, as described herein. Accordingly, non-transitory computer-readable storage medium, such as the storage component 232, the memory component 234, and/or the database 228 may be utilized for storing the logic for execution.

### Example Hardware Configurations for Edge Environment

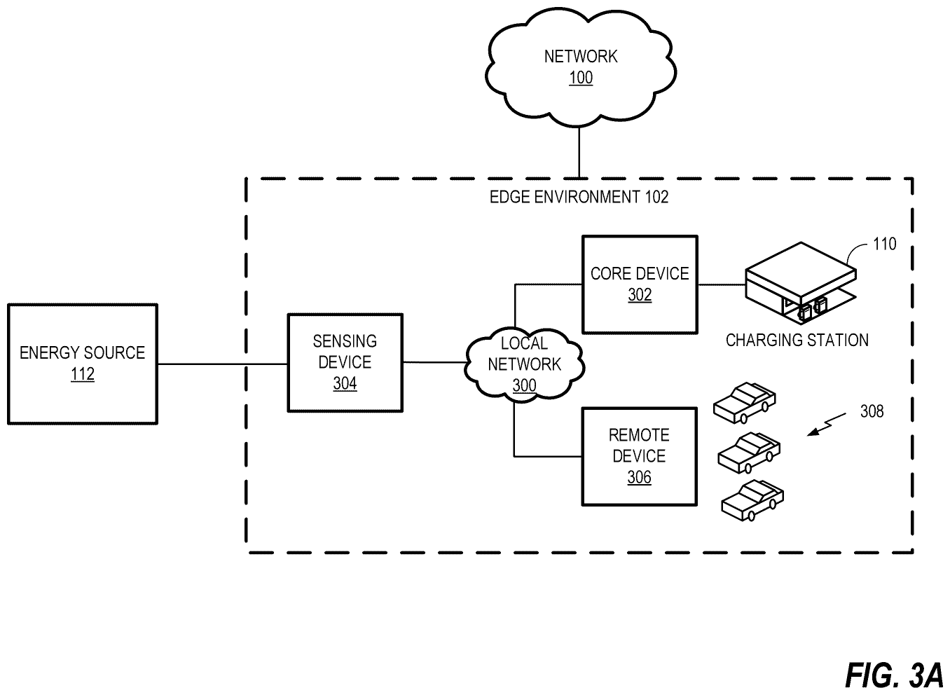

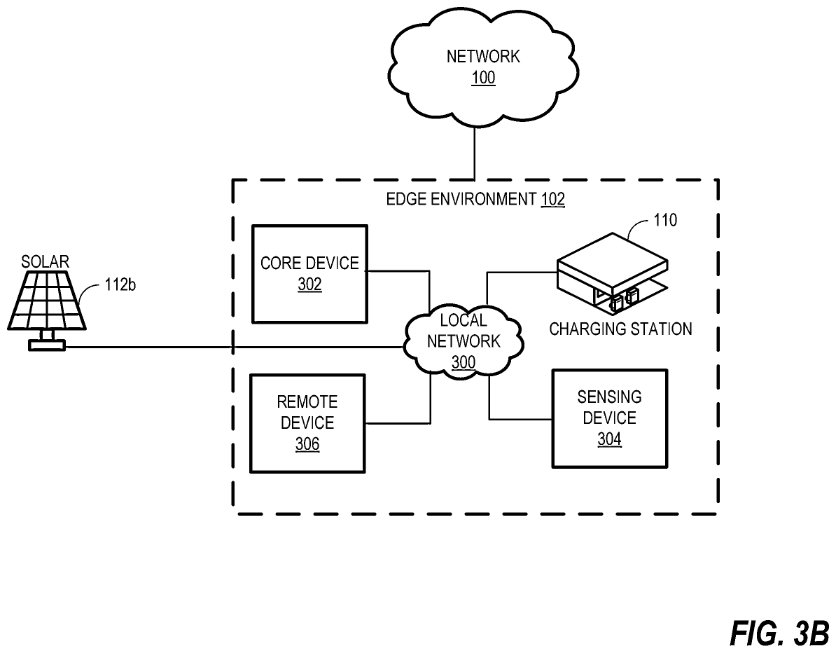

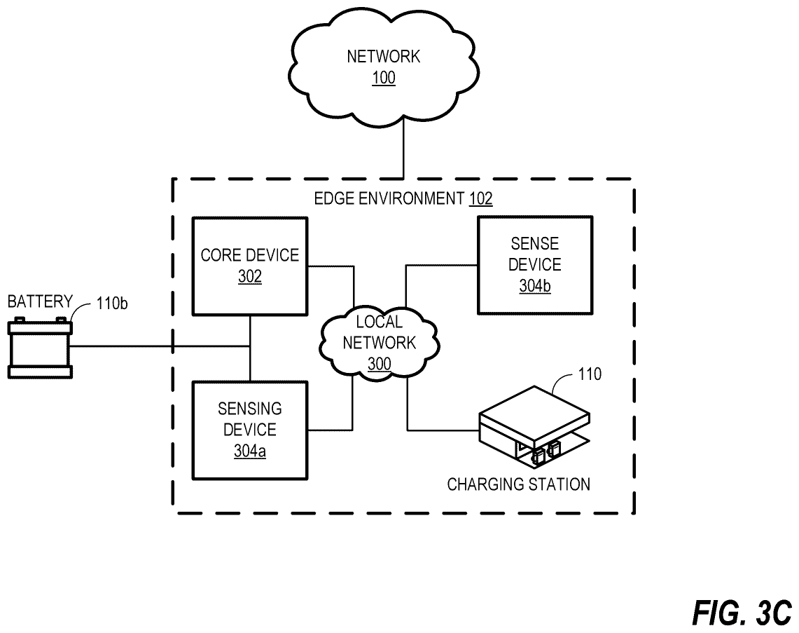

FIGS. 3A-3C depict example hardware configurations for the edge environment 102, according to embodiments provided herein. Specifically, FIG. 3A depicts a charging solution. As illustrated, the charging station 110 is coupled to a local network 300 via core device 302. The local network 300 may include any local area network, Ethernet, personal access network, etc., as described above with reference to the network 100 from FIG. 1. The core device 302 may be physically installed within communications range of the chargers in the charging station 110. A sensing device 304 may be installed, for example, in an electrical room or in another enclosure with electrical equipment of the charging station 110 and/or one or more energy sources 112 to monitor the main metering point for the local utility point of common coupling. This enables algorithms to provide the optimal dispatch of EV charging power, subject to local energy rates and the vehicles currently charging. In the case that there are vehicles 308 using EV chargers that are out of communications range of the core device 302, such as a sub-level of a parking garage, a remote device 306 are included as required.

In the embodiment of FIG. 3A, the core device 302 is the central processing device and serves as the communications hub. The core device 302 may provide optimization, load management, communication coordination, and data historian services. The core device 302 communicates with the cloud environment 104 either via cellular modem, or wired internet service provider (ISP) 104 to get the latest optimization and load management set points for charging stations 110 and other assets. As such, the core device 302 dispatches these set points, through a local communications protocol (e.g., Wi-Fi) and/or via the remote device 306 to reach locations that are distant or hard to reach, such as charging stations 110 for vehicles 308 at sub-levels of a parking garage or a rooftop solar inverter. The core device 302 additionally collects data directly from the energy sources 112 or through cloud-based communications with the network 100.

Power and energy metering data may be collected via the sensing device 304. The sensing device 304 may include a smart meter with support for multiple single-and three-phase loads with a local historian and Ethernet communication back to the device via the local network 300. The sensing device may also incorporate support for additional devices running on the edge including but not limited to thermocouple wiring, weather stations, temperature sensors, pyranometers, etc. It should be noted that additional sensing devices 304 and remote devices 306 can be added to handle variable situations, such as a separate subpanel for energy metering of a new solar or for monitoring of a new inverter associated with a rooftop solar installation.

FIG. 3B depicts a solar application where the core device 302 and the sensing device 304 are installed in the facility's electrical room or other common area. The sensing device 304 can monitor the main metering point for the local utility as well as the solar production at tie-in breakers for the solar device 112b. The remote device 306 may be installed in a position to communicate directly with the solar device 112b and report the data received from the solar device 112b to the core device 302. Accordingly, the core device 302, the sensing device 304, and the remote device 306 depicted in FIG. 3B may perform similar functions as those devices depicted in FIG. 3A.

FIG. 3C depicts a battery application where the core device 302 and the sensing device 304 are physically installed near a battery 112c storage installation. In cases where the battery 112c is near the point of common coupling with the utility 112d, a single sensing device 304a can monitor the full site. In cases where there is a significant distance to the metering point for the utility 112d, a second sensing device 304b (or a plurality of sensing devices 304b) may be installed near the utility meter, such as the electrical room.

### Example Hardware components in Core, Sense, and Remote

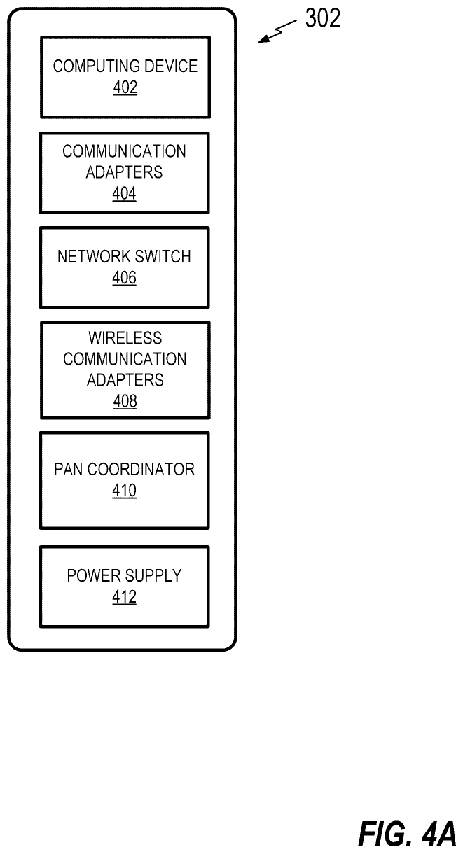

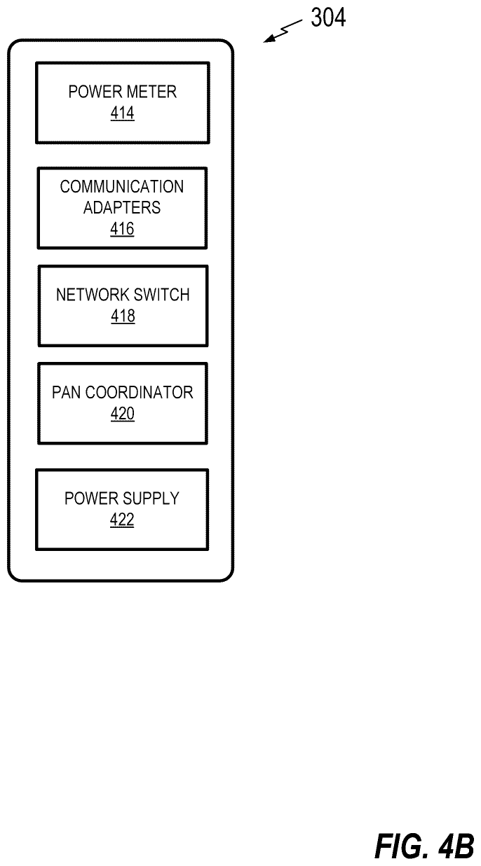

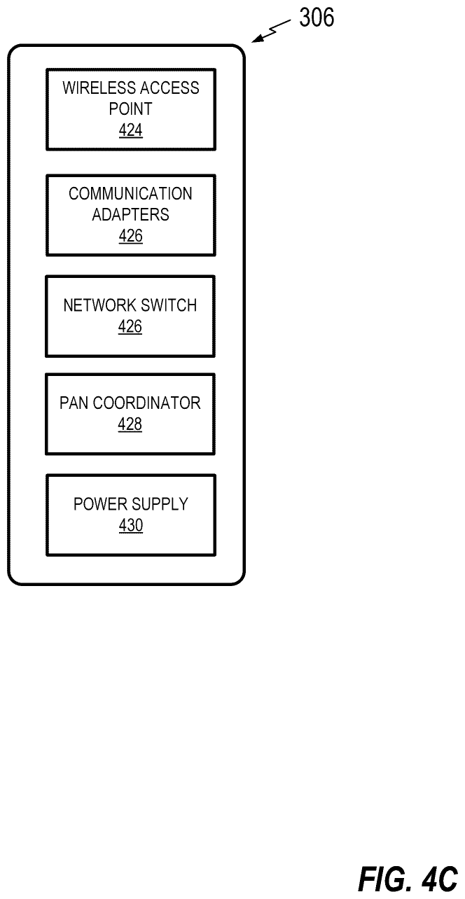

FIGS. 4A-4C depict hardware that may be utilized for the devices from FIGS. 3A-3C, according to embodiments provided herein. Specifically, FIG. 4A depicts hardware components that may be present in a core device 302. In some embodiments, the core device 302 is the brain where the energy optimization and adaptive load management functions are executed and dispatched. As illustrated, the core device 302 may include a computing device 402, a communication adapter 404 (or more than one), a network switch 406, a wireless communication adapter 408, a PAN coordinator 410, and a power supply 412. As will be understood, the computing device 402 may include a processor, memory, and/or other components that a normal, specific purpose machine may utilize. In some embodiments, the computing device 402 may include powerline communication (PLC) infrastructure, while some embodiments may utilize retail and/or micro-industrial computer components for optimization, load management, communication coordination, and/or historian services.

The communication adapter 404 may be configured for load balancing and otherwise managing communications and, for example, may be configured as a Modubus RTU (RS485) to Modbus TCP (Ethernet) or Ethernet IP (RJ45) to Ethernet Optical (SFP), etc. The network switch 406 may be configured for routing of network traffic, and may be configured as an Ethernet switch for communication to other nodes (e.g., the sense device 304, the remote device 306, and/or other core device 302), distributed energy resources, and/or energy based management systems.

The wireless communication adapter 408 may include a cellular modem, internet modem, Wi-Fi access point, etc. for facilitating wireless communications to the internet or other wide area network. Similarly, the PAN coordinator 410 may be configured to create and/or join communication connections with other devices. This may include a Zigbee coordinator, Bluetooth device, and/or other device for performing this function. The power supply 412 may be configured as a battery power, connection to external power, etc.

FIG. 4B depicts hardware components of the sense device 304 from FIGS. 3A-3C. The sense device 304 may be configured as a smart-metering piece for collection and storage of power/energy data including but not limited to measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. These embodiments may be optimized for case of installation and reduced intrusion to the site. Power over Ethernet (POE) sourced from the core device 302 suffices for most installations. The sense device 304 may transmit data back to the core device 302 via a network switch. The sense device 304 is optimized to utilize minimal power and PoE is acceptable for most installations.

As illustrated in FIG. 4B, the sense device 304 includes a power meter 414, a communication adapter 416, a network switch 418, and may include a PAN coordinator 420, and a power supply 422. The power supply 422 may include a power interface for providing power to the sense device 304. The power meter 414 may be utilized for monitoring single-phase and three-phase loads of power. The communication adapter 416 may be utilized for facilitating communications between the sense device 304 and other devices. The network switch 418 may be a PoE enabled switch for communication. Similarly, the PAN coordinator 410 may create and/or join personal area networks, such as via Zigbee, Bluetooth, and the like.

As illustrated in FIG. 4C, the remote device 306 is a network-connectivity extension, primarily for EV charging or solar monitoring locations where Zigbee, Wi-Fi, or Ethernet is being extended to remote or difficult-to-reach locations such as remote subpanels, parking garage levels, or rooftop inverters. Some embodiments are optimized for ease of installation and reduced intrusion to the site where PoE suffices for most installations from the core device 302. The remote device 306 may be configured to transmit data back to the core device 302 via the network switch 406.

Specifically, the remote device 306 may include a wireless access point 424, a communication adapter 426, a network switch 428, and may include a PAN coordinator 430, and a power supply 432. The wireless access point 424 may be configured to extend wireless communication signals to chargers and/or other intelligent electronic devices. The communication adapter 426 may be configured for facilitating communications between the remote device 306 and other devices. The network switch 428 may be configured as a POE Ethernet switch and/or other network switch for communicating with the core device 302. The PAN coordinator 430 may be configured to create and/or join personal area networks, such as via Zigbee, Bluetooth, and the like. The power supply 432 may include a power interface for providing power to the sense device 304.

### Example Use Cases

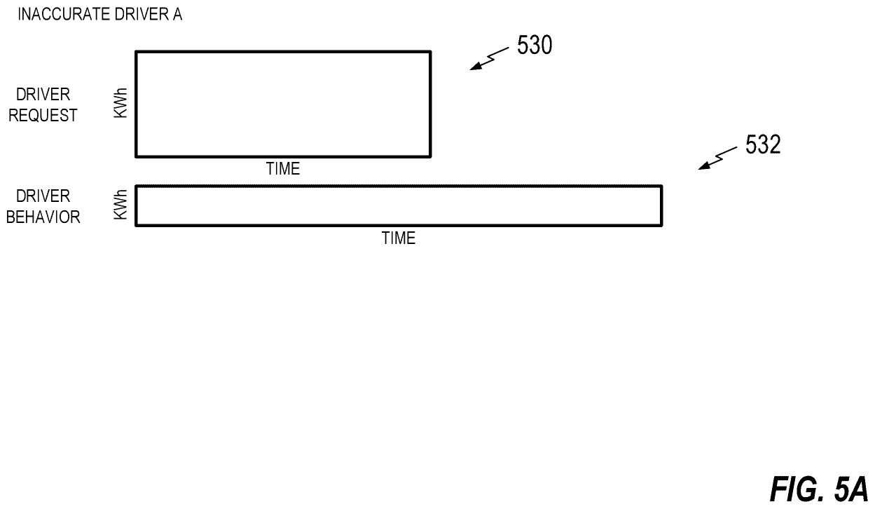

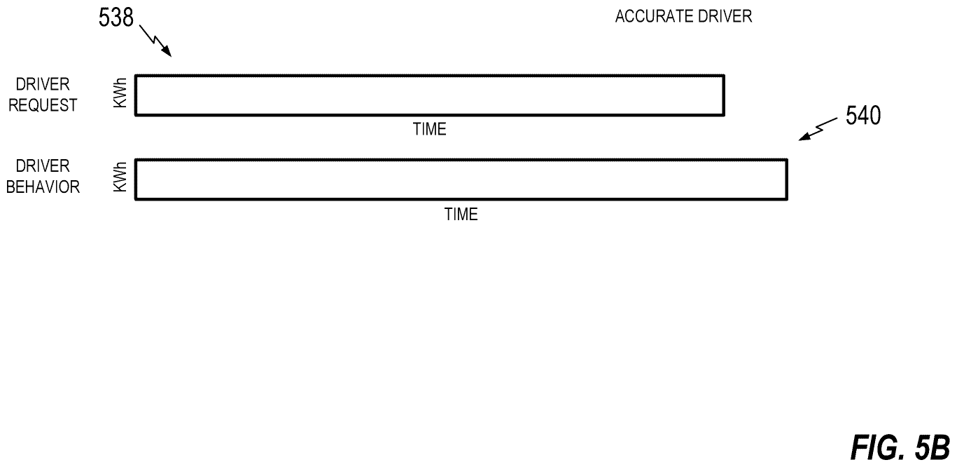

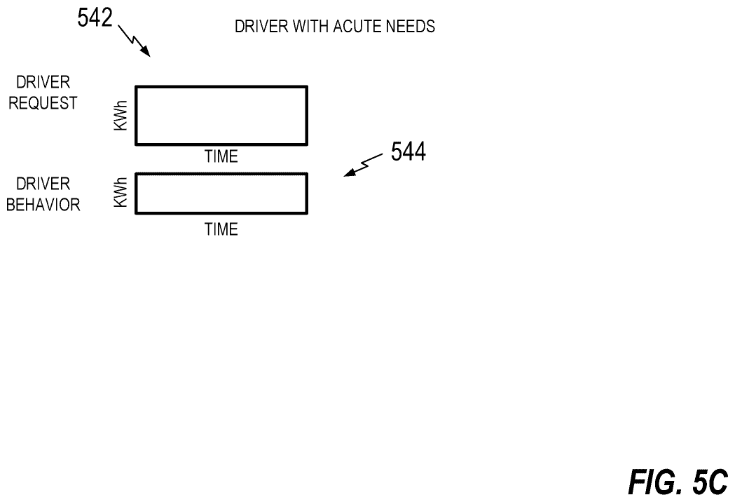

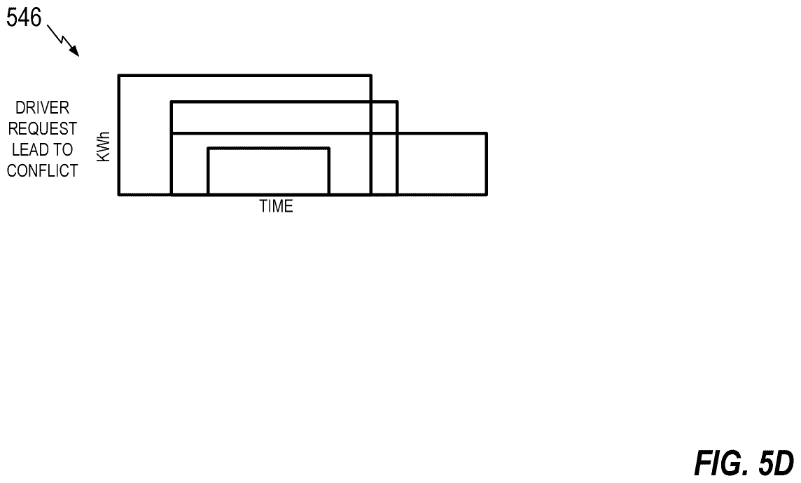

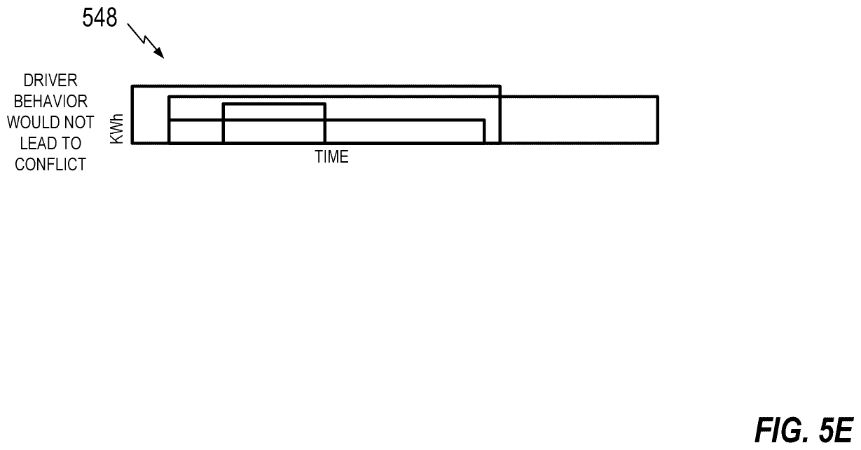

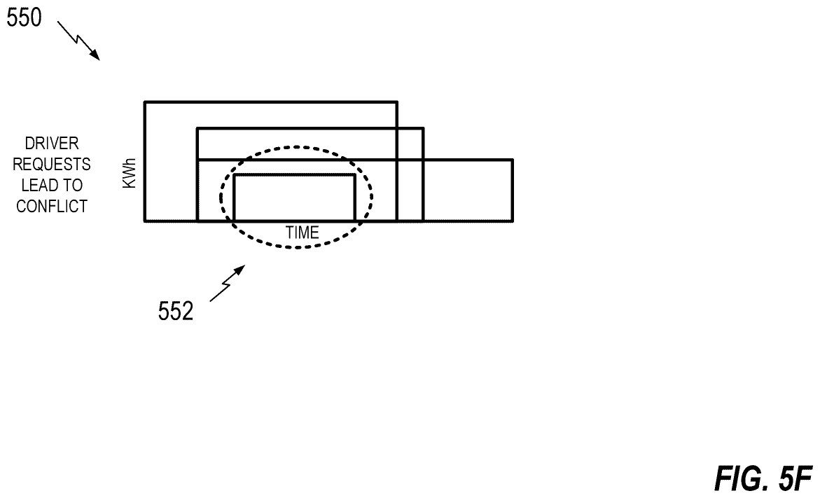

FIGS. 5A-5G depict a plurality of plots comparing a user's charge request to a user's actual charge behavior. As illustrated in FIG. 5A, a driver request may include a time dimension (horizontal axis in FIGS. 5A-5G) and an energy dimension (vertical axis). The request may come from a mobile device 114c via the network 100 (FIG. 1). Specifically, the mobile device 114c may provide the user with a user interface (such as via a mobile app) that allows the user to make the charge request. In some embodiments, the charge request may default to a values that the user configured for a different charging session based on a different need, or the user may merely resubmit the same values for each charge request regardless of need. The charge request may be received by the edge environment 102 (FIG. 1), such as via the service interconnect 224 (FIG. 2). The edge cluster 208 may receive the request and allocate resources of the requested charging station 110, via the edge gateway 202. As illustrated in FIG. 5A, plot 530 depicts a driver request that has an energy component and a time component (e.g., 50 KWh and 6 hours).

Additionally, when the user plugs a vehicle into a charging port at the charging station 110 (FIGS. 1, 2), the edge gateway 202 may receive data regarding the time spent plugged in and the energy provided to the EV. This information may be sent to the edge cluster 208. The edge cluster 208 may cause the data to be stored in the storage component 232. Additionally, the edge cluster 208 may compare the charge request to the actual use to determine how truthful the user has been with this request. As illustrated in FIG. 5A, the user requested a greater energy delivery rate and a smaller delivery time than was actually utilized. It should be understood that the smaller the request for time requires the charging station 110 to deliver the requested amount of energy to the vehicle, leading to prioritization of that charger (via that user/vehicle's perceived need), which gets prioritized by the automated load management. Thus, if the vehicle stays plugged into the charging station 110 after the requested time, that is evidence that other vehicles could have been prioritized, had this user provided an accurate charge request.

FIG. 5C depicts an accurate (e.g., truthful) user charge request. Specifically, plots 538 and 540 depict that the user requested approximately the same energy as was delivered. Similarly, the driver requested the energy to be delivered in an amount of time that was slightly shorter than the actual time spent at the charging station 110, but within a reasonable amount.

Accordingly, some embodiments may provide an administrator setting for determining the threshold for accuracy of a charge request. As an example, some embodiments may indicate that two deviations of difference between the charge request and actual charge delivery indicates a pattern of inaccuracy that requires charge request modification. Another example could be that a predetermined percentage difference indicates inaccuracy that requires charge request modification. Some embodiments may utilize a predetermined percentage (or a predetermined number) of charge requests as inaccurate (e.g., the top 10 most inaccurate charge requests are deemed “inaccurate” regardless of how egregious or benign). Other examples may also be set by the administrator.

FIG. 5C depicts plots 542, 544 of a charge request and charge delivery of a user with a time-sensitive request. Specifically, the user may have an actual time sensitive need for charging. In this scenario, the plots 542, 544 are reasonable close, indicating that the user is accurate in this charge request, but the short duration indicates that he/she should be prioritized in receiving a charge.

FIG. 5D depicts a plurality of charge request plots 546 that lead to conflict, thus compromising user experience. Specifically, because there are a large number of high energy requests at the same time, the charging station 110 (FIG. 1) is incapable of providing the requested energy to all users per their respective requests. In particular, the driver in FIG. 5C actually has an acute need to charge. Additionally, because the requested times are relatively short, there is insufficient time to prioritize the charging to accommodate all of the user charge requests. While it is possible that each of the users is being accurate with their charge requests, when a portion of the users are not being accurate (purposefully or otherwise), an unnecessary strain on resources and a reduced user experience may result.

FIG. 5E depicts a plurality of request plots 548 that would not lead to conflict. Specifically, because each of the charge requests are for a small amount of energy and the timeframes for providing that energy are elongated, embodiments provided herein can effectively prioritize the requests to provide all of the users the requested (and needed) energy in the time requested.

FIG. 5F depicts a plurality of request plots 550 further illustrating the specific requests 552 that lead to the conflict. Because all of the requests within the circle (and during the time within the circle) result in a higher energy demand than all of the charging station 110 at a charging site can provide, a conflict results.

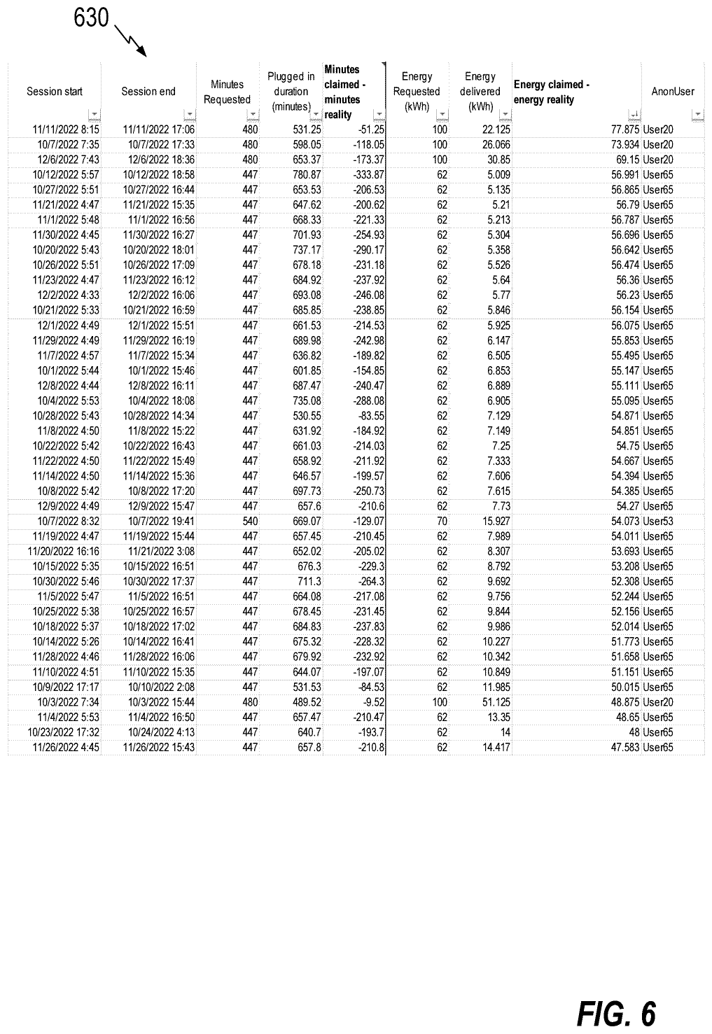

FIG. 6 depicts a table 630 further illustrating historical charge session data of various users, where each row is associated with a unique charge session. Table 630 illustrates session start an end times, minutes requested, minutes used, the difference between minutes requested and used, energy requested, energy delivered, the difference between energy requested and delivered, and a user identifier.

Specifically, embodiments provided herein may be configured to classify a user as inaccurate in response to determining that a charge request from the user has been labeled “inaccurate” at a predetermined rate. Some embodiments may indicate that a user is labeled “inaccurate” if a predetermined number of their charge requests have been labeled inaccurate. Some embodiments may label a user inaccurate, based on how egregious the requests are (e.g., if a user's requests are two standard deviations from actual need, it takes fewer inaccurate requests than a user whose requests are only one standard deviation from actual need). Some embodiments may label a user inaccurate, based on the resources of the particular charging station 110. Specifically, some charging stations 110 may have fewer charging bays, but can provide higher rates of energy delivery. Such charging stations 110 may prioritize time accuracy over total energy accuracy. Regardless of the mechanism for determining if a user is accurate, some embodiments may provide an administrator option for setting that mechanism. Notably, when a user has been labeled as inaccurate according to any of the aforementioned methods, the charge control system may modify the user's charge request based on that user's historical data to automatically improve the accuracy of the user's charge request. In some cases the user may be made aware of such modification (e.g., by a message, notification, indication, or the like), while in other cases the user may not be made aware of the modification.

Referring back to FIG. 6, User20 has charged three times. Depending on the mechanism for determining accuracy of charge requests, User20 has been inaccurate on each of his/her charge requests. However, User20 has been more accurate with the time requests. User65, however, has made 40 requests, all with a large discrepancy in total energy requested versus total energy delivered. Additionally, many of the time requests for User65 have been inaccurate compared to the actual time used during the charge session. Depending on the criteria for labeling a user as “inaccurate,” User65 may be deemed less accurate than user User20, and thus more likely to have their charge request modified by the system.

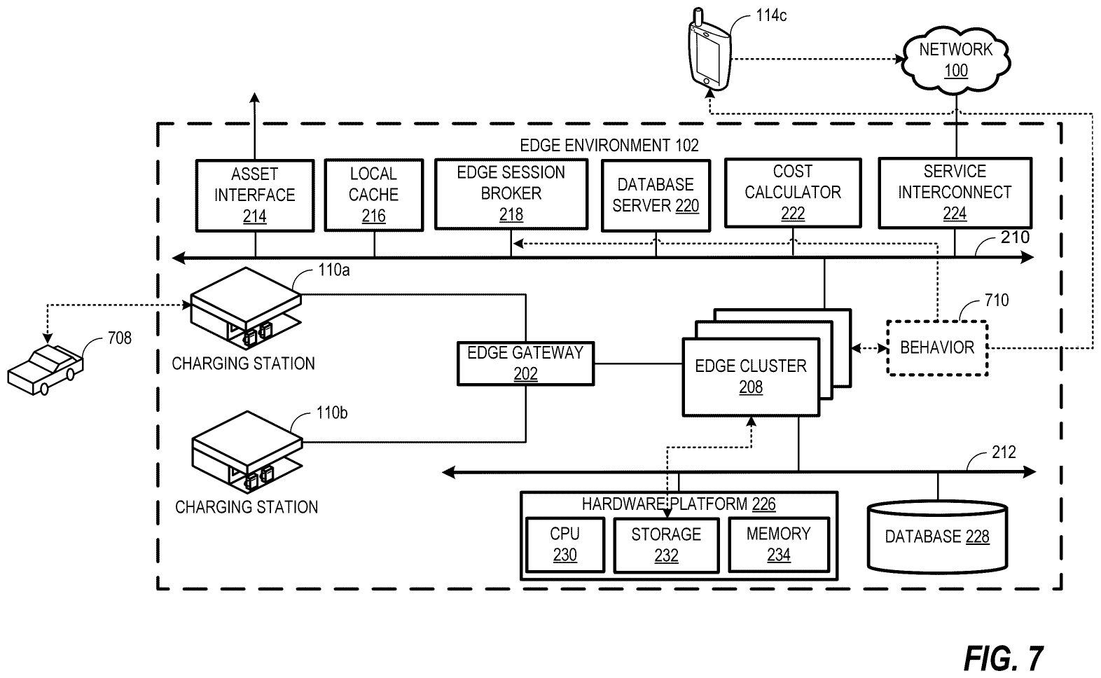

FIG. 7 depicts a flow diagram depicting an implementation of charge request modification via the edge environment 102 from FIGS. 1 and 2. As illustrated, the edge environment 102 from FIG. 2 is reproduced, with the mobile device 114c sending user preferences, including a charge request, to the edge environment 102 via the network 100. The edge cluster 208 may receive the user preferences and store this data in the storage component 232.

Additionally, a vehicle 708 of the user may plug into the charging station 110a to begin charging. The edge gateway 202 may receive data from the vehicle related to the actual energy being provided, as well as a time the vehicle 708 is plugged into the charging station 110a. The edge gateway 202 may normalize this data and send to the edge cluster 208. The edge cluster 208 may cause the new behavior 710 to be stored in the storage component 232, as well as inform the edge session broker 218 of the new session (behavior 710). Upon completion of the charge, the edge cluster 208 may determine whether or not the charge request was accurate. The accuracy of this charge request may be stored by the edge cluster 208 in the storage component 232. Additionally, a determination of whether the user is accurate with respect to his/her charge request may also be performed by the edge cluster 208, based on criteria determined by an administrator. If the user is deemed inaccurate, the edge cluster 208 may provide a user interface to the mobile device 114c and encourage (e.g., through messaging) the user to update the charge request information. If the user agrees to update the information, the user's profile and designation of being inaccurate may be temporarily suspended or reset entirely. If the user chooses to not update the charge request information, the user may be allowed to charge based on the current charge request information a predetermined number of times until a charge request modification is mandated by the system. In other words, if the user does not become more accurate during the predetermined number of charging sessions, the system may automatically modify the charge request information to restrict the amount of energy that may be requested and/or the energy delivery deadlines.

### Example Process

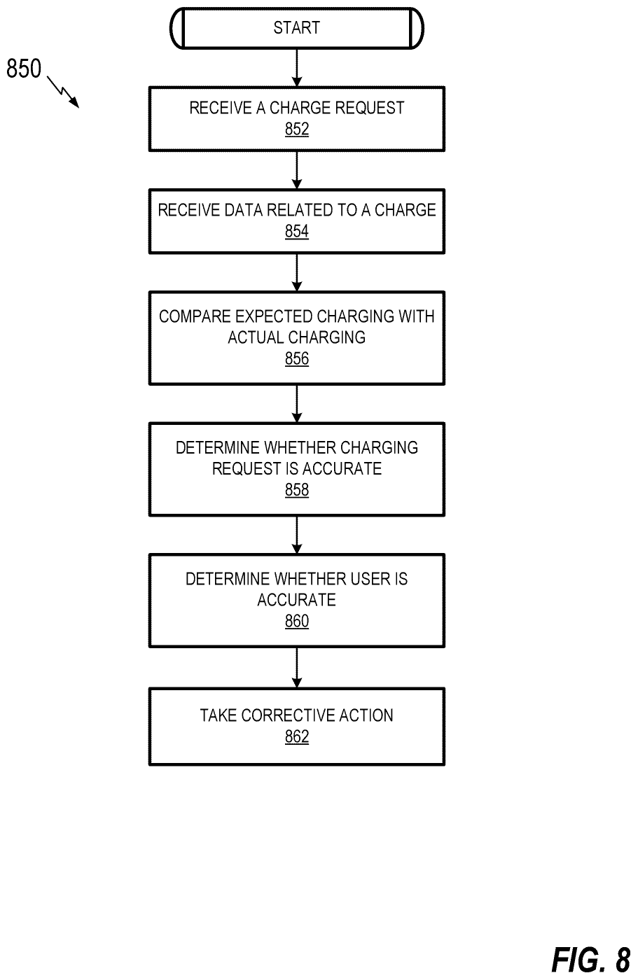

FIG. 8 depicts a flowchart 850 for providing charge request modification, according to embodiments provided herein.

As illustrated in block 852, a charge request for a charging station 110 that includes an expected charging time and an expected energy delivery for charging an EV is received. As described above, the charge request may be received from the mobile device 114c, via a charge request information graphical user interface.

In block 854, data related to a charge at the charging station 110 that is associated with the charge request may be received. Specifically, when the user actually charges the EV, data related to the charge and time the EV says plugged into the charging station 110 are recorded and sent to the edge environment 102. In some embodiments the data includes a vehicle identifier, a user identifier, a timestamp, an actual charging time, and/or an actual energy delivery for the EV.

In block 856, the expected charging time may be compared with the actual charging time and the expected energy delivery may be compared with the actual energy delivery.

In block 858, a determination may be made, based on comparing and a predetermined threshold for accuracy, whether the charge request was accurate. As described above, the predetermined threshold for accuracy may be determined by an administrator. Some embodiments may determine accuracy based on the charge request versus charge received. If the user historically requests more charge than the EV eventually receives (or needs), embodiments may identify the charging session and/or user as inaccurate. Some embodiments may determine that a user is inaccurate if the user demands charge in a time that is less than the user keeps the EV on the charger (relative to a threshold). Some embodiments may use charge inaccuracies and/or time inaccuracies to determine whether a user or charge session are inaccurate, using a predetermined weighting and threshold. As an example, a determination may be made that a user is labeled as inaccurate if he/she is [>10% on time or >15% on charge received] or [>7% on time and >10% on charge]. Depending on the particular embodiment such a weighting may be determined by an administrator and/or may be determined by the edge environment 102 and/or cloud environment 104, based on user history (generally for all users or user-specific history).

As an example, embodiments may be configured to determine a starting alteration for the threshold(s) for all users and determine how effective the alteration is to encouraging the desired behavior. If the overall users do not change behavior and/or do not behave to a desired threshold (or desired results related to charging capacity are not realized by the charging station 110), the alteration may change to accomplish both the desired user behavior and the desired charging capacity. As suggested above, this may be set for all users and/or may be determined and set on an individual basis to encourage each user to provide accurate requests. These examples improve the technical field of dynamic charging by optimizing accuracy in user behavior to dynamically provide desired charge at peak times.

In block 860, a determination may be made based on historical charge request accuracies, whether the user is accurate. In some embodiments, determining whether the user is accurate is based on predetermined criteria. As described above, determining whether a user is accurate may be based on number of inaccurate charge requests, how inaccurate the charge requests are, etc. and may also be set by an administrator.

In block 862, in response to determining that the user is not accurate, corrective action may be taken to encourage the user to adjust a future charge request to become more accurate. As described above, the corrective action may include providing a user interface and/or other prompt (e.g., message, notification, indication) inviting the user to update his/her charge request information, automatically modifying future charge requests from the inaccurate user based on historical data and averages for the user, etc. Modifying future charge requests may include automatically discounting any time and/or duration request by a predetermined threshold. As an example, if the user requests 50 KWh in an hour, but the user has a history of being 10% incorrect, some embodiments may increase the time and/or decrease the energy request by 10% (or other percentage).

Similarly, some embodiments may be configured to stop charging at a predetermined time, charge level, energy transferred, etc. and resume charging if or when other demand has declined to a predetermined threshold. As an example, if the user is inaccurate in his/her requests by 10% or more, these embodiments may be configured to stop charging once the vehicle is 50% charged and only resume if or when the charging station has at least 50% capacity.

If the user is determined to be accurate, the user's charge requests may be prioritized normally according to the load management scheme used by the system. Accordingly, this block may only be performed by a charging station 110, edge environment 102, and/or cloud environment 104 (and not a human) because this block includes determining historical accuracy of the user, as well as determining current charge request, charge distributed in this charging session, as well as control of the charging station. This also improves the technical field of charge distribution by rationing charge based on these factors, as well as current usage.

Note that FIG. 8 is just one example of a method, and other methods including fewer, additional, or alternative steps are possible consistent with this disclosure. Additionally, it should be understood that these embodiments improve the technical field EV energy allocation by improving the speed at which energy is delivered, based on actual need and time sensitivity.

### Example Clauses

Implementation examples are described in the following numbered clauses:

Clause 1: A method, comprising: receiving, by an edge environment, a charge request from a user for a charging station that includes an expected charging time and an expected energy usage for charging an electric vehicle (EV); receiving, by the edge environment, data related to a charge at the charging station that is associated with the charge request, wherein the data includes an actual charging time and an actual energy usage for the EV; comparing, by the edge environment, the expected charging time with the actual charging time and the expected energy usage with the actual energy usage; determining, by the edge environment, based on comparing and a predetermined threshold for accuracy, whether the charge request was accurate; determining, by the edge environment, from data related to whether the charge request was accurate and other data associated with whether another charge request of the user was accurate, whether the user is accurate, wherein determining whether the user is accurate is based on predetermined criteria; and in response to determining that the user is not accurate, taking, by the edge environment, corrective action to encourage the user to adjust a future charge request to become more accurate.

Clause 2: The method of clause 1, wherein taking corrective action includes providing a prompt to a mobile device of the user to adjust the future charge request.

Clause 3: The method of clause 1 and/or 2, wherein taking corrective action includes automatically adjusting the future charge request to be more accurate, based on historical charging by the user.

Clause 4: The method of any of clauses 1 through 3, wherein determining whether the charge request was accurate includes at least one of the following: determining a number of standard deviations the expected charging time differs from the actual charging time, determining a number of standard deviations the expected energy usage differs from the actual energy usage, determine whether a difference between the expected charging time and the actual charging time exceeds a predetermined percentage difference, or determining whether the difference between the expected energy usage and the actual energy usage exceeds a predetermined percentage difference.

Clause 5: The method of any of clauses 1 through 4, wherein determining whether the user is inaccurate includes at least one of the following: determining whether predetermined number of charge requests from the user have been labeled inaccurate, or determining whether a number of inaccurate requests from the user meet a predetermined threshold.

Clause 6: The method of any of clauses 1 through 5, wherein determining whether the user is inaccurate is based on an administrative setting.

Clause 7: The method of any of clauses 1 through 6, wherein determining whether the charge request is inaccurate is based on an administrator setting.

Clause 8: A system, comprising: an edge environment that includes a memory component and a processor, the edge environment including an edge cluster that, when executed by the processor, causes the system to perform at least the following: receive a charge request from a user for a charging station that includes an expected charging time and an expected energy usage for charging an electric vehicle (EV); receive data related to a charge at the charging station that is associated with the charge request, wherein the data includes an actual charging time and an actual energy usage for the EV; compare the expected charging time with the actual charging time and the expected energy usage with the actual energy usage; determine, based on comparing and a predetermined threshold for accuracy, whether the charge request was accurate; determine, from data related to whether the charge request was accurate and other data associated with whether another charge request of the user was accurate to, whether the user is accurate, wherein determining whether the user is accurate is based on predetermined criteria; and in response to determining that the user is not accurate, take corrective action to encourage the user to adjust a future charge request to become more accurate.

Clause 9, The system of clause 8, wherein taking corrective action includes providing a prompt to a mobile device of the user to adjust the future charge request.

Clause 10: The system of clause 8 and/or 9, wherein taking corrective action includes automatically adjusting the future charge request to be more accurate, based on historical charging by the user.

Clause 11: The system of any of clauses 8 through 10, wherein determining whether the charge request was accurate includes at least one of the following: determining a number of standard deviations the expected charging time differs from the actual charging time, determining a number of standard deviations the expected energy usage differs from the actual energy usage, determine whether a difference between the expected charging time and the actual charging time exceeds a predetermined percentage difference, or determining whether the difference between the expected energy usage and the actual energy usage exceeds a predetermined percentage difference.

Clause 12: The system of any of clauses 8 through 11, wherein determining whether the user is inaccurate includes at least one of the following: determining whether predetermined number of charge requests from the user have been labeled inaccurate, or determining whether a number of inaccurate requests from the user meet a predetermined threshold.

Clause 13: The system of any of clauses 8 through 12, wherein determining whether the user is inaccurate is based on an administrative setting.

Clause 14: The system of any of clauses 8 through 13, wherein determining whether the charge request is inaccurate is based on an administrator setting.

Clause 15: A non-transitory computer-readable storage medium that includes logic, that, when executed by a computing device, causes the computing device to perform at least the following: receive a charge request from a user for a charging station that includes an expected charging time and an expected energy usage for charging an electric vehicle (EV); receive data related to a charge at the charging station that is associated with the charge request, wherein the data includes an actual charging time and an actual energy usage for the EV; compare the expected charging time with the actual charging time and the expected energy usage with the actual energy usage; determine based on comparing and a predetermined threshold for accuracy, whether the charge request was accurate; determine from data related to whether the charge request was accurate and other data associated with whether another charge request of the user was accurate to, whether the user is accurate, wherein determining whether the user is accurate is based on predetermined criteria; and in response to determining that the user is not accurate, take corrective action to encourage the user to adjust a future charge request to become more accurate.

Clause 16: The non-transitory computer-readable storage medium of clause 15, wherein taking corrective action includes providing a prompt to a mobile device of the user to adjust the future charge request.

Clause 17: The non-transitory computer-readable storage medium of clause 15 and/or 16, wherein taking corrective action includes automatically adjusting the future charge request to be more accurate, based on historical charging by the user.

Clause 18: The non-transitory computer-readable storage medium of any of clauses 15 through 17, wherein determining whether the charge request was accurate includes at least one of the following: determining a number of standard deviations the expected charging time differs from the actual charging time, determining a number of standard deviations the expected energy usage differs from the actual energy usage, determine whether a difference between the expected charging time and the actual charging time exceeds a predetermined percentage difference, or determining whether the difference between the expected energy usage and the actual energy usage exceeds a predetermined percentage difference.

Clause 19: The non-transitory computer-readable storage medium of any of clauses 15 through 18, wherein determining whether the user is inaccurate includes at least one of the following: determining whether predetermined number of charge requests from the user have been labeled inaccurate, or determining whether a number of inaccurate requests from the user meet a predetermined threshold.

Clause 20: The non-transitory computer-readable storage medium of any of clauses 15 through 19, wherein determining whether the user is inaccurate is based on an administrative setting and wherein determining whether the charge request is inaccurate is based on an administrator setting.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving, by an edge environment, a charge request from a user for a charging station that includes an expected charging time and an expected energy usage for charging an electric vehicle (EV);
receiving, by the edge environment, data related to a charge at the charging station that is associated with the charge request, wherein the data includes an actual charging time and an actual energy usage for the EV;
comparing, by the edge environment, the expected charging time with the actual charging time and the expected energy usage with the actual energy usage;
determining, by the edge environment, based on comparing and a predetermined threshold for accuracy, whether the charge request was accurate;
determining, by the edge environment, from data related to whether the charge request was accurate and other data associated with whether another charge request of the user was accurate, whether the user is accurate wherein determining whether the user is accurate is based on predetermined criteria; and
in response to determining that the user is not accurate, taking, by the edge environment, corrective action to encourage the user to adjust a future charge request to become more accurate.

2. The method of claim 1, wherein taking corrective action includes providing a prompt to a mobile device of the user to adjust the future charge request.

3. The method of claim 1, wherein taking corrective action includes automatically adjusting the future charge request to be more accurate, based on historical charging by the user.

4. The method of claim 1, wherein determining whether the charge request was accurate includes at least one of the following: determining a number of standard deviations the expected charging time differs from the actual charging time, determining a number of standard deviations the expected energy usage differs from the actual energy usage, determine whether a difference between the expected charging time and the actual charging time exceeds a predetermined percentage difference, or determining whether the difference between the expected energy usage and the actual energy usage exceeds a predetermined percentage difference.

5. The method of claim 1, wherein determining whether the user is inaccurate includes at least one of the following: determining whether predetermined number of charge requests from the user have been labeled inaccurate, or determining whether a number of inaccurate requests from the user meet a predetermined threshold.

6. The method of claim 1, wherein determining whether the user is inaccurate is based on an administrative setting.

7. The method of claim 1, wherein determining whether the charge request is inaccurate is based on an administrator setting.

8. A system, comprising:
an edge environment that includes a memory component and a processor, the edge environment including an edge cluster that, when executed by the processor, causes the system to perform at least the following:
receive a charge request from a user for a charging station that includes an expected charging time and an expected energy usage for charging an electric vehicle (EV);
receive data related to a charge at the charging station that is associated with the charge request, wherein the data includes an actual charging time and an actual energy usage for the EV;
compare the expected charging time with the actual charging time and the expected energy usage with the actual energy usage;
determine, based on comparing and a predetermined threshold for accuracy, whether the charge request was accurate;
determine, from data related to whether the charge request was accurate and other data associated with whether another charge request of the user was accurate to, whether the user is accurate, wherein determining whether the user is accurate is based on predetermined criteria; and
in response to determining that the user is not accurate, take corrective action to encourage the user to adjust a future charge request to become more accurate.

9. The system of claim 8, wherein taking corrective action includes providing a prompt to a mobile device of the user to adjust the future charge request.

10. The system of claim 8, wherein taking corrective action includes automatically adjusting the future charge request to be more accurate, based on historical charging by the user.

11. The system of claim 8, wherein determining whether the charge request was accurate includes at least one of the following: determining a number of standard deviations the expected charging time differs from the actual charging time, determining a number of standard deviations the expected energy usage differs from the actual energy usage, determine whether a difference between the expected charging time and the actual charging time exceeds a predetermined percentage difference, or determining whether the difference between the expected energy usage and the actual energy usage exceeds a predetermined percentage difference.

12. The system of claim 8, wherein determining whether the user is inaccurate includes at least one of the following: determining whether predetermined number of charge requests from the user have been labeled inaccurate, or determining whether a number of inaccurate requests from the user meet a predetermined threshold.

13. The system of claim 8, wherein determining whether the user is inaccurate is based on an administrative setting.

14. The system of claim 8, wherein determining whether the charge request is inaccurate is based on an administrator setting.

15. A non-transitory computer-readable storage medium that includes logic, that, when executed by a computing device, causes the computing device to perform at least the following:
receive a charge request from a user for a charging station that includes an expected charging time and an expected energy usage for charging an electric vehicle (EV);
receive data related to a charge at the charging station that is associated with the charge request, wherein the data includes an actual charging time and an actual energy usage for the EV;
compare the expected charging time with the actual charging time and the expected energy usage with the actual energy usage;
determine based on comparing and a predetermined threshold for accuracy, whether the charge request was accurate;
determine from data related to whether the charge request was accurate and other data associated with whether another charge request of the user was accurate to, whether the user is accurate, wherein determining whether the user is accurate is based on predetermined criteria; and
in response to determining that the user is not accurate, take corrective action to encourage the user to adjust a future charge request to become more accurate.

16. The non-transitory computer-readable storage medium of claim 15, wherein taking corrective action includes providing a prompt to a mobile device of the user to adjust the future charge request.

17. The non-transitory computer-readable storage medium of claim 15, wherein taking corrective action includes automatically adjusting the future charge request to be more accurate, based on historical charging by the user.

18. The non-transitory computer-readable storage medium of claim 15, wherein determining whether the charge request was accurate includes at least one of the following:
determining a number of standard deviations the expected charging time differs from the actual charging time, determining a number of standard deviations the expected energy usage differs from the actual energy usage, determine whether a difference between the expected charging time and the actual charging time exceeds a predetermined percentage difference, or determining whether the difference between the expected energy usage and the actual energy usage exceeds a predetermined percentage difference.

19. The non-transitory computer-readable storage medium of claim 15, wherein determining whether the user is inaccurate includes at least one of the following: determining whether predetermined number of charge requests from the user have been labeled inaccurate, or determining whether a number of inaccurate requests from the user meet a predetermined threshold.

20. The non-transitory computer-readable storage medium of claim 15, wherein determining whether the user is inaccurate is based on an administrative setting and wherein determining whether the charge request is inaccurate is based on an administrator setting.
